(19) United States
(12) Patent Application Publication
(10) Pub. No.: US 2017/0288254 A1
(43) Pub. Date: Oct. 5, 2017

(54) FUEL CELL STACK WITH TENSION DEVICE

(71) Applicant: FORD GLOBAL TECHNOLOGIES, LLC, Dearborn, MI (US)

(72) Inventors: Stephan STRAHL, Bodenwoehr (DE); Uwe GUSSEN, Huertgenwald (DE); Arnulf SPONHEIMER, Aachen (DE)

(73) Assignee: FORD GLOBAL TECHNOLOGIES, LLC, Dearborn, MI (US)

(21) Appl. No.: 15/476,274

(22) Filed: Mar. 31, 2017

(30) Foreign Application Priority Data
Mar. 31, 2016 (DE) 10 2016 205 282.9

(51) Int. Cl. H01M 8/248; H01M 8/2404; H01M 8/241

(52) U.S. Cl. CPC H01M 8/248; H01M 8/241; H01M 8/2404

(57) ABSTRACT

The invention relates to a fuel cell stack having a cell stack of mutually adjacently arranged individual cells and a tension device for compressing the cell stack. Each individual cell has two electrode layers and an electrolyte layer arranged between the electrode layers. The tension device contains at least one tension element, which extends from one end of the cell stack to the other end of the cell stack. The fuel cell stack furthermore contains at least one piezo actuator for pressing an end plate against one end of the cell stack. The invention furthermore relates to a corresponding method for operating a fuel cell stack.

### CROSS-REFERENCE TO RELATED APPLICATION

This application claims foreign priority benefits under 35 U.S.C. §119(a)-(d) to DE Application 10 2016 205 282.9, filed Mar. 31, 2016, which is hereby incorporated by reference in its entirety.

### TECHNICAL FIELD

The invention relates to a fuel cell stack having a cell stack of mutually adjacently arranged individual cells and a tension device for compressing the cell stack. The invention furthermore relates to a method for operating a fuel cell stack.

### BACKGROUND

A fuel cell stack normally contains a multiplicity of individual cells, which are mutually adjacently arranged in a cell stack and in which chemical energy is converted directly into electrical energy in each case through a reaction of a fuel with an oxidizing agent. Each individual cell in turn comprises a plurality of plates or layers, of which two are designed as electrodes. An electrolyte layer is arranged between the electrodes. Further layers are, for example, gas diffusion layers for the uniform distribution of the gaseous fuel and the oxidizing agent, or separating layers for delimitation with respect to adjacent individual cells. Seals at the outer edge of the layers or plates prevent an undesired effusion of the gases and fluids. Depending on the chemical reaction, each individual cell generates an electrical voltage of approximately 1 volt. With a stack-like arrangement of many individual cells, these are operated in a series connection, whereby a correspondingly high output voltage is produced at the ends of the fuel cell stack.

During operation of the fuel cell stack, the fuel and the oxidizing agent are introduced into the cell stack under a pressure within a preferred pressure range. The fuel cell stack is furthermore normally operated in a temperature range above the ambient temperature, with an additional heating taking place as a result of the chemical reaction. Conventional fuel cell stacks therefore have a tension device which presses the individual cells against one another. The tension device comprises an end plate at both ends of the stack in each case. The end plates are connected to one another for example by tension rods or tension bands and compress the cell-stack stack. This prevents fuel or oxidizing agent from escaping and achieves a good electrical conductivity as a result of an extensive contact between all layers or plates of the individual cells.

To avoid damage to the seals or individual layers of the individual cells, the tension device must furthermore enable a thermal expansion or contraction of the fuel cell stack in as flexible a manner as possible. To this end, for example, spring elements are provided between the tension rods or tension bands and the end plates at one or at both end plates. With this measure, it is ensured that, even during a contraction or expansion of the stack, the individual cells and the layers or plates contained therein are compressed with a predetermined force.

The patent application US 2002/0110722 A1 describes a fuel cell stack having a metal pressure bellows between the cell stack and an end plate. The pressure bellows can be acted upon by a pressurized gas and compresses the stack instead of spring elements. By changing the pressure in the pressure bellows, the pressure force can be adapted quickly and flexibly to a desired value.

A similar principle for compressing individual cells in a fuel cell stack is described in the patent application US 2009/0246585 A1. A chamber, which can be acted upon by fuel under pressure, is provided between the layers in each individual cell. The surrounding layers or plates are pressed outwards by the pressure in the chamber. The individual cells arranged in a rigid frame are compressed by the pressure in the chambers. A controllable valve is provided for each individual cell to regulate the pressure in the chamber. The valve contains for example a piezo element for controlling the valve.

A fuel cell stack having a tension device which is pre-tensioned by spring elements is disadvantageous in that a pressure prevailing against the end plates depending on the expansion of the stack is specified prior to operation and can no longer be adapted during operation. Also, the spring elements can become fatigued during the service life of the fuel cell stack, as a result of which gas leaks or faulty electrical contacts can occur in or between individual cells. In a fuel cell stack having a pressure bellows or pressure chambers in the individual cells, the pressure for compressing the stack can also be regulated during operation. However, for this purpose, a variable pressure valve and a corresponding control are required for the pressure bellows or for each individual cell. This results in a more complex and failure-prone construction of the fuel cell stack.

### SUMMARY

An object of the present invention is to provide a fuel cell stack and a method for operating a fuel cell stack, in which the said disadvantages are avoided or at least reduced and, in particular, a reliable and uncomplicated adjustment of the pressure for compressing a cell stack is also possible during operation.

The object is achieved according to the invention by a fuel cell stack having a cell stack of mutually adjacently arranged individual cells and a tension device for compressing the cell stack. In this, each individual cell has two electrode layers and an electrolyte layer arranged between the electrode layers. The tension device contains at least one tension element which extends from one end of the cell stack to the other end of the cell stack. The fuel cell stack furthermore contains at least one piezo actuator for pressing an end plate against one end of the cell stack.

In addition to the electrode layers and the electrolyte layer, the individual cells of a fuel cell stack according to the invention can have further plates or layers, for example gas diffusion layers (GDL) for the uniform distribution of the fuel and the oxidizing agent, separating layers for the delimitation with respect to adjacent individual cells or sealing layers for preventing fuel, oxidizing agent or electrolyte fluid from escaping. The layers or plates of an individual cell are arranged in particular in a sandwich-like manner and can be surrounded by seals at the edge. A fuel cell stack according to the invention contains, as individual cells, for example, proton exchange membrane fuel cells or other cell types known to the person skilled in the art. In this context, hydrogen or a gaseous hydrocarbon, such as methane, is preferably used as a fuel and oxygen is used, for example, as an oxidizing agent. The individual cells are preferably mutually adjacently arranged in a sandwich-like manner such that an electrical series connection of the individual cells is formed. To supply fuel and oxidizing agent to the individual cells and to discharge a reaction product, the fuel cell stack furthermore comprises appropriately designed lines or channels.

The tension device comprises, for example, one or more tension bolts, one or more tension bands, a frame or a combination of these elements as tension elements. The tension device ensures in particular a flexible holding-together and compression of the cell stack of individual cells in the event of different thermal expansions. To this end, in the fuel cell stack according to the invention, at least one piezo actuator acts on the end plate provided at one end of the cell stack. The piezo actuator contains, for example, a piezo crystal, a piezoelectric ceramic, or a stack of individual elements of one of these materials. Piezoelectric materials assume a different volume depending on the electrical voltage applied. Depending on the electrical voltage applied, the piezo actuator acts to a greater or lesser extent on the end plate. The end plate preferably has an area which corresponds to, or is similar to, the cross-section of the cell stack and serves for the homogenous distribution of the pressure generated by the piezo actuator to the end of the cell stack. The at least one piezo actuator here is preferably held in position by the tension element(s).

The inventive fuel cell stack for operating a fuel cell system is particularly suitable for mobile applications, for example for generating electrical energy in motor vehicles. By means of the at least one piezo actuator, the pressure against the end plate for compressing the cell stack can be adjusted in a flexible and very precise manner. An inadequate pressure caused by the effects of aging on the tension device and resultant leaks are effectively prevented. Likewise, damage to individual cells or seals as a result of too high a pressure in the event of a high thermal expansion of the cell stack is efficiently avoided.

According to a preferred embodiment of the invention, an end plate and at least one piezo actuator for pressing the end plate against the respective end of the cell stack are provided in each case at both ends of the cell stack. For example, a piezo actuator is arranged at each of the two end plates such that its pressure regions lie against the respective end plate on an axis parallel to the longitudinal axis of the cell stack. The piezo actuators therefore compress both end plates along an axis parallel to the longitudinal axis of the cell stack. A compression of the cell stack here can therefore take place symmetrically from both ends. By comparison with a fuel cell stack having piezo actuators at only one end, a possible or necessary displacement of individual cells as a result of the compression is distributed more uniformly over the entire cell stack.

According to a further advantageous embodiment of the invention, a plurality of piezo actuators are provided at one end plate. One piezo actuator is preferably provided for one of a plurality of regions of the end plate in each case. For example, one of four piezo actuators can be arranged at each corner of a rectangular end plate. According to one embodiment, a plurality of piezo actuators, in particular four piezo actuators in each case, are provided at both end plates in each case. Different regions of the end plate, and therefore different longitudinal regions of the cell stack, can therefore be acted upon by a different pressure. It is thus possible, for example, to compensate an inhomogenous thermal expansion over a cross-section of the cell stack resulting from heating differences during operation. A bending of the cell stack relative to the longitudinal axis resulting from different thermal expansions can be effectively prevented by generating a corresponding pressure at individual regions of the end plate.

In one embodiment of the fuel cell stack according to the invention, a lever mechanism is preferably provided, by way of which at least one piezo actuator acts on the end plate. The lever mechanism contains one or more levers and is preferably designed such that a small actuating travel of the piezo actuator is converted into a larger lever travel at the end plate. For example, the lever mechanism contains a one-sided lever in which the piezo actuator is arranged between a lever joint and a free end of the lever, in particular near to the lever joint, and the lever end acts on the end plate. The adjustment travel of the piezo actuator is preferably increased by the lever mechanism. As a result of this measure, it is possible to achieve an adequate adjustment travel at the end plate with a relatively small volume of a piezoelectric material. The piezo actuator can be designed in a more compact and space-saving manner.

In one embodiment of the fuel cell stack according to the invention, the piezo actuator is furthermore arranged between a tension plate which abuts against the at least one tension element and a lever which is pivotally mounted on the tension plate. For example a tension plate is provided in each case at both ends of the cell stack, which tension plates are held at a predetermined spacing by one or more tension elements, such as tension bands or tension bolts. Depending on the actuation, the piezo actuator preferably pivots one end of the lever towards the end plate or away from this. The lever can be designed in particular as a one-sided lever. A plurality of levers having one or more piezo actuators in each case can also be provided at each tension plate. In this case, each lever presses against a different region of the end plate. A very compact and effective tension device for the fuel cell stack is realized as a result.

In one embodiment of the fuel cell stack according to the invention, a piezo element is provided as a pressure sensor at one of the end plates. The piezo element contains for example a piezo crystal, a piezoelectric ceramic or a stack of individual elements of one of these materials. A corresponding electrical voltage is generated in piezoelectric materials depending on the pressure applied. The pressure is measured by measuring the electrical voltage which occurs. One or more piezo elements are arranged for example between two individual cells of the cell stack, between an end plate and the cell stack or in a tension device for the fuel cell stack. The piezo element advantageously enables a reliable and precise pressure measurement in a specific region of the cell stack.

In one embodiment of the fuel cell stack according to the invention, a piezo actuator is preferably designed both for generating and for measuring the pressure on one of the end plates. In particular, one piezo actuator, a plurality of piezo actuators or all piezo actuators are used alternately for generating and for measuring the pressure on an end plate. Further piezo elements can additionally be provided for measuring the pressure at different points of the fuel cell stack. An economical fuel cell stack is realized in particular as a result of the double function of the piezo actuator(s).

In a preferred embodiment of the fuel cell stack according to the invention, a control device is furthermore provided for actuating at least one piezo actuator whilst taking into account a current operating state of the fuel cell stack. For example, a current energy consumption or a current load, an ambient temperature, a temperature or a pressure within the fuel cell stack or a pressure at a region of an end plate are taken into account by the control device. To this end, the control device can contain an electronic processor for processing data and a memory for storing data. In addition to processing pressure values of one or more piezo elements or piezo actuators, the control device can also be designed for processing values of additional sensors, such as temperature or current sensors. By processing the values provided, the control device determines an optimum actuation of the piezo actuator(s) depending on the operating state. A compression of the cell stack which is adapted to current operating states is ensured at all times.

The object is furthermore achieved by a method for operating a fuel cell stack, which comprises supplying a fuel and an oxidizing agent to a multiplicity of individual cells which are mutually adjacently arranged in a cell stack and have in each case two electrode layers and an electrolyte layer arranged between the electrode layers. The method furthermore comprises compressing the cell stack during operation by means of a tension device. During the compression, an end plate is pressed against one end of the cell stack. The method furthermore comprises actuating at least one piezo actuator for pressing the end plate against the one end of the cell stack.

Analogously to the fuel cell stack according to the invention, the method according to the invention enables the pressure against the end plate for compressing the cell stack to be adjusted in a flexible and very precise manner at all times by actuating the at least one piezo actuator. Leaks resulting from the effects of aging on the tension device can be avoided.

Further embodiments of the method according to the invention correspond in each case to described embodiments of the fuel cell stack and have corresponding features and advantages.

The above and further advantageous features of the invention are illustrated in the detailed description below of exemplary inventive embodiments with reference to the accompanying schematic drawings, which show:

### BRIEF DESCRIPTION OF THE DRAWINGS

FIG. 1 is a schematic illustration of an exemplary embodiment of a fuel cell stack according to the invention in a side view;

FIG. 2 is a schematic plan view of one end of the fuel cell stack according to FIG. 1 and an arrangement of the lever and piezo actuators at a tension plate (not shown);

FIG. 3 is a schematic illustration of an actuation of piezo actuators for compressing the cell stack of the fuel cell stack according to FIG. 1;

FIG. 4 is a schematic illustration of an actuation of piezo actuators for compensating a first bending of a cell stack of the fuel cell stack according to FIG. 1;

FIG. 5 is a schematic illustration of an actuation of piezo actuators for compensating a second bending of a cell stack of the fuel cell stack according to FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the exemplary embodiments described below, elements which are functionally or structurally similar to one another are provided with the same or similar reference numerals wherever possible. Therefore, to understand the features of the individual elements of a figure, please also refer to the description of other figures or the general description of the invention. The functionality of the exemplary embodiments of a fuel cell stack is described below in each case together with an exemplary embodiment of a corresponding method for operating a fuel cell stack.

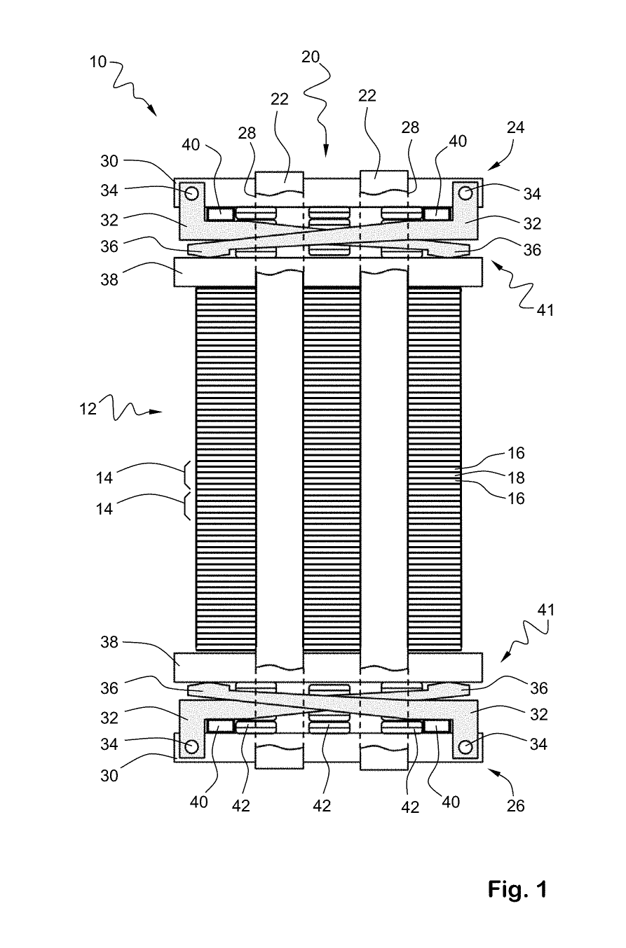

FIG. 1 shows a schematic illustration of a fuel cell stack 10. The fuel cell stack 10 contains a cell stack 12 having a multiplicity of mutually adjacently arranged individual cells 14. The individual cells 14 are arranged with their long side faces against one another in a sandwich-like manner such that an electrical series connection of the individual cells 14 is realized. Each individual cell 14 is supplied with a fuel, for example hydrogen, methane or another gaseous hydrocarbon, and with an oxidizing agent, for example oxygen, by way of channels or lines (not illustrated) of the fuel cell stack 10. A discharge line (not illustrated in FIG. 1) for reaction products is provided accordingly for each individual cell 14. An electrical voltage or energy generated by the cell stack 12 is provided at both ends of the cell stack 12 by electrical contacts (likewise not illustrated). The fuel cell stack 10 in this embodiment is designed for a mobile application, for example in a vehicle and, to this end, is configured to be as light and compact as possible.

To generate electrical energy, each individual cell 14 contains two electrode layers 16 in each case and an electrolyte layer 18 arranged between them. Each individual cell 14 can additionally contain further layers or plates, for example gas diffusion layers (GDL) arranged on the electrode layers 16 for the uniform distribution of fuel and oxidizing agent over the entire surfaces of the electrode layers 16 and separating plates for separating the individual cells 14. An individual separating plate, a so-called bipolar plate, can be provided here for two adjacent individual cells 14. Channels for supplying fuel and oxidizing agent and for discharging reaction products can moreover be contained in the separating plates. Furthermore, for each individual cell 14, seals are provided at the outer edge of the cell stack 12 or as further plates or layers to prevent fuel, oxidizing agent, reaction product or electrolyte fluid from escaping from the cell stack 12. The individual cells 14 are designed for example as proton exchange membrane fuel cells having a proton exchange membrane (PEM) as an electrolyte layer, to name but one of many individual cell types which may be used in the fuel cell stack 10 and are known to the person skilled in the art.

To compress and hold the cell stack 12 together, the fuel cell stack 10 furthermore contains a tension device 20. The tension device 20 has four tension elements 22 designed as tension bands, which extend in each case from a first end 24 of the fuel cell stack 10 to a second end 26. The tension elements 22 are arranged in pairs at opposite sides of the cell stack 12 and extend parallel to one another and to a longitudinal axis of the cell stack 12. In FIG. 1, two tension elements 22 are represented by remote portions 28 at the ends 24, 26 of the fuel cell stack 10 to show elements and structures behind them. The four tension elements 22 each hold a tension plate 30 at the first end 24 and at the second end 26 of the fuel cell stack 10 at a fixed maximum spacing from one another. In alternative embodiments, it is possible to use more than or fewer than four tension bands, one tubular tension band guided around both ends 24, 26 and along two opposite sides instead of two tension bands, or tension bolts instead of tension bands. A rigid frame having integrated tension elements and tension plates is possible. It is merely important that the tension plates 30 are at a fixed spacing from one another to thereby constitute a counter-bearing for generating pressure on the cell stack 12.

Four levers 32, of which only two are visible in FIG. 1, at each end 24, 26 of the fuel cell stack 10, are in each case pivotally mounted on each of the two tension plates 30 by way of joints 34. The levers 32 abut with their free end 36 against an end plate 38 which transmits force from the levers 32 uniformly to one end of the cell stack 12. To this end, the end plates 38 provided at both ends of the cell stack 12 abut against the respective end of the cell stack 12 over the entire surface thereof and have an area which corresponds to, or is similar to, the cross-section of the cell stack. At each lever 32, a piezo actuator 40 is arranged in the vicinity of the joint 34 between a bearing surface of the lever 32 and the tension plate 30. Depending on the adjustable expansion of the piezo actuator 40, the lever 32 is pressed to a greater or lesser extent against the end plate 38. The levers 32 therefore constitute one-sided levers which convert a slight expansion of the piezo actuators 40 into a greater deflection at the free ends 36 of the levers 32. The tension plate 30, together with the levers 32 and the joints 34, constitutes a lever mechanism 41 for the piezo actuators 40.

Each of the total of eight piezo actuators 40 contains a piezo crystal, a piezoelectric ceramic, or a stack of individual elements of one of these materials. Piezoelectric materials assume a different volume depending on the electrical voltage applied. By applying a specific electrical voltage by means of a control device (not illustrated), the piezo actuator 40 assumes a corresponding expansion between the tension plate 30 and the lever 32. In alternative embodiments, it is possible to provide two-sided levers instead of one-sided levers, levers and piezo actuators at only one end 24, 26 of the fuel cell stack 10 or more than or fewer than four piezo actuators and levers per end 24, 26. In this embodiment, spring elements 42 are furthermore arranged at each end 24, 26 between the tension plate 30 and the end plate 38 for additionally pressing the end plate 38 against the cell stack 12. The spring elements 42 are designed for example as disk springs or helical springs.

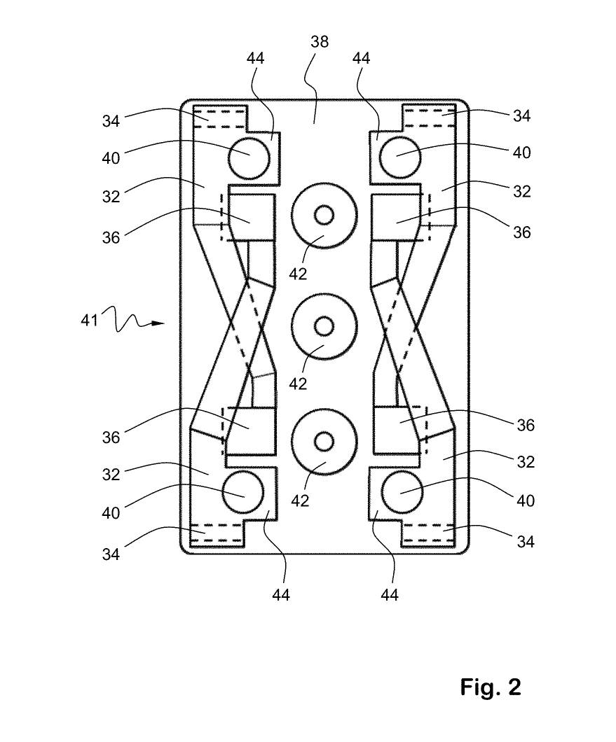

FIG. 2 shows a schematic plan view of one end of the fuel cell stack 10 according to FIG. 1 without the tension plate 30. The arrangement of the levers 32 and the piezo actuators 40 with respect to the end plate 38 is clearly shown. In the region of a corner of the end plate 38, each lever 32 is connected at one end to the tension plate 30 (not shown) by way of the joint 34. A pin, which is mounted on the tension plate and extends into a bore in the lever 32, is provided for example as the joint 34. The pivot axes of the lever 32 are therefore parallel to the dashed lines at the joints 34. Each lever 32 furthermore extends along a side edge of the end plate 38 and into the opposite corner of the end plate 38, where the free end 36 of the lever 32 acts on the end plate 38 with a lever head. Two levers 32 are arranged crossed in each case here and designed such that they do not restrict each other in terms of their clearance.

Adjacent to the joint 34, each lever has a bearing surface 44 against which the respective piezo actuator 40 abuts. The piezo actuators 40 are held in position by the tension plate 30, which is in turn fixed in place by the tension elements 22. A very compact and space-saving tension device 20 is realized by such an arrangement of the levers 32 and piezo actuators 40. This arrangement requires piezo actuators 40 with small adjustment travels, and therefore small dimensions, as a result of the lever 32, which is designed to be as long as possible. Furthermore, three spring elements 42 designed for example as disk springs or helical springs are arranged at the center of the end plate 38. Alternatively, more than or fewer than three spring elements 42 can be provided. The spring elements 42 exert an additional pressure on the end plate 38, in particular in its central region.

Each piezo actuator 40 can be actuated individually by a control device (not shown) by adjusting an electrical voltage accordingly. It is thus possible to adapt the pressure on the cell stack 12 separately in the region of each corner of the cell stack 12. The piezo actuators 40 and the control device are furthermore also provided for measuring a pressure. Instead of generating pressure, it is therefore also possible to carry out a measurement of the pressure acting on the piezo actuator 40 by way of the end plate 38 and the lever 32 at each corner of the cell stack 12. The control device takes into account, for example, a current energy consumption, an ambient temperature, a temperature or a pressure within the fuel cell stack, or a pressure at a region of an end plate upon the actuation of the piezo actuators 40. To this end, the control device can also be designed for processing values of additional sensors, such as temperature or current sensors, and can contain an electronic processor for processing data and a memory for storing data. By processing the values provided, the control device determines an optimum actuation of the piezo actuators 40 depending on the operating state.

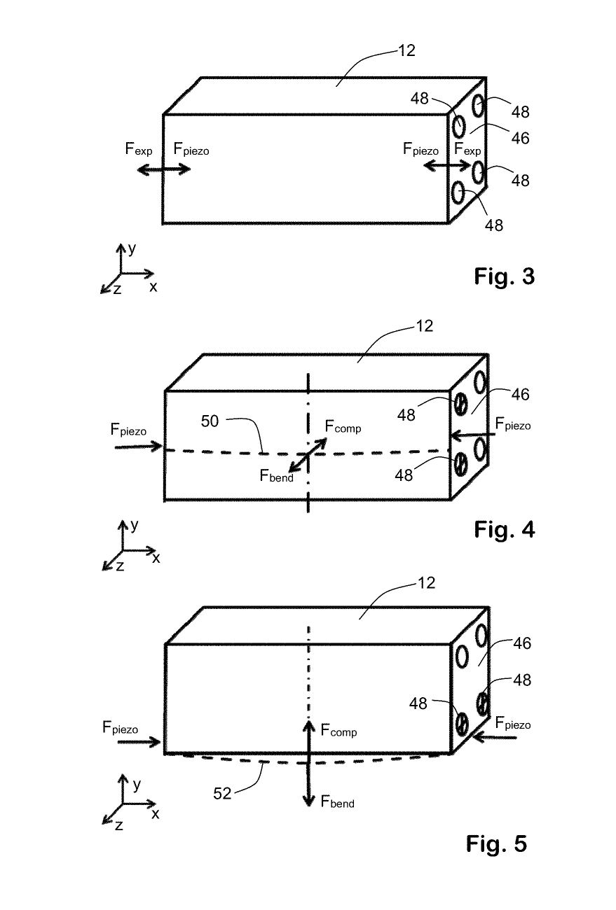

FIGS. 3 to 5 illustrate the fuel cell stack 10 in different operating states and a corresponding actuation of the piezo actuators 40 in a schematic view. To facilitate the description, a Cartesian xyz coordinate system is shown in these figures. The x axis is selected parallel to the longitudinal axis of the fuel cell stack 10 and the cell stack 12. The longitudinal axis of the fuel cell stack 10 is substantially perpendicular to the large outer faces of the end plates 38 and the individual layers or plates of the individual cells 14.

FIG. 3 shows the cell stack 12 schematically as a cuboid. The end plates 38 (not shown) abut in each case against the end faces 46 or ends of the cell stack 12, which are perpendicular to the x direction. The pressure on a region of the end face 46 can be adjusted during operation in each case by the four piezo actuators 40 by way of the levers 32 and the end plates 38. The pressure regions 48 are symbolized as a circle. By measuring the pressure at these pressure regions 48 by means of the piezo actuators 40, a current pressure can be determined at all times during operation. A precisely specified pressure is then generated by actuating the piezo actuators 40 for each pressure region 48 at both end faces 46. The tension device 20 therefore reacts flexibly to a thermal expansion or contraction of the cell stack 12 during operation and compresses the cell stack 12 at each of the pressure regions 48 with a predetermined pressure. A force Fₑₓₚ acting on the end faces in the x direction as a result of expansion is compensated by a corresponding force F_{piezo} of the piezo actuators 40.

FIG. 4 illustrates the cell stack 12 of the fuel cell stack 10 in an operating state in which a bending 50 in the z direction has occurred for example as a result of an inhomogenous thermal heating or pressurization with fuel or oxidizing agent. This bending 50 is caused by a force F_{bend} acting in the z direction. This force F_{bend} can be compensated by the tension device 20 through the generation of a corresponding counter force F_{comp}. To this end, a force F_{piezo} is generated on the pressure regions 48 denoted by a cross by means of two of the piezo actuators 40. This one-sided, or—by way of opposing piezo actuators—symmetrical, action on the cell stack 12 generates the force F_{comp} in the cell stack 12 for the purpose of rectifying the bending 50. Analogously, the bending 52 (shown in FIG. 5) of the cell stack 12 in the negative y direction can be counteracted by an actuation of the two piezo actuators 40 for the pressure regions 48 denoted by a cross. By actuating the piezo actuators 40 for the two pressure regions 48 which are located at the edge of that side face of the cell stack 12 which faces in the bending direction, a force F_{comp} can be generated in the cell stack. This force F_{comp} counteracts the bending force F_{bend}. Therefore, with four piezo actuators 40 for one end face 46, bendings of the cell stack 12 can be effectively rectified and disruptive forces occurring in the cell stack 12 can be compensated in the x, y and z direction.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fuel cell stack having a cell stack of mutually adjacently arranged individual cells and a tension device compressing the cell stack, wherein each individual cell has two electrode layers and an electrolyte layer arranged between the electrode layers,
the tension device contains at least one tension element which extends from one end of the cell stack to the other end of the cell stack, and
the fuel cell stack contains at least one piezo actuator for pressing an end plate against one end of the cell stack.

2. The fuel cell stack as claimed in claim 1, wherein an end plate and at least one piezo actuator for pressing the end plate against the respective end of the cell stack are provided in each case at both ends of the cell stack.

3. The fuel cell stack as claimed in claim 1, wherein a plurality of piezo actuators are provided at one end plate.

4. The fuel cell stack as claimed in claim 1, wherein a lever mechanism is provided, by way of which at least one piezo actuator acts on the end plate.

5. The fuel cell stack as claimed in claim 4, wherein the piezo actuator is arranged between a tension plate which abuts against the at least one tension element and a lever which is pivotally mounted on the tension plate.

6. The fuel cell stack as claimed in claim 1, wherein
a piezo element is provided as a pressure sensor at one of the end plates.

7. The fuel cell stack as claimed in claim 1, wherein a piezo actuator is designed both for generating and for measuring the pressure on one of the end plates.

8. The fuel cell stack as claimed in claim 1, wherein a control device is provided for actuating at least one piezo actuator whilst taking into account a current operating state of the fuel cell stack.

9. A method for operating a fuel cell stack, comprising:
supplying a fuel and an oxidizing agent to a multiplicity of individual cells which are mutually adjacently arranged in a cell stack and have in each case two electrode layers and an electrolyte layer arranged between the electrode layers;
compressing the cell stack during operation by means of a tension device, wherein an end plate is pressed against one end of the cell stack during the compression, and
actuating at least one piezo actuator for pressing the end plate against the one end of the cell stack.
